(19) United States
(12) Patent Application Publication
(10) Pub. No.: US 2010/0271815 A1
(43) Pub. Date: Oct. 28, 2010

(54) CLIP-ON DECORATIVE LED LIGHT

(75) Inventor: Michael A. Gomez, Glen Cove, NY (US)

Correspondence Address: MATTHEW E. BURR, 620 CONGRESS AVENUE, STE 320, AUSTIN, TX, 78701, US

(73) Assignee: Lights International Group, Inc., Glen Cove, NY (US)

(21) Appl. No.: 12/604,967

(22) Filed: Oct. 23, 2009

Related U.S. Application Data
(60) Provisional application No. 61/108,105, filed on Oct. 24, 2008.

(51) Int. Cl. F21L 4/02; F21S 4/00; F21V 9/00

(52) U.S. Cl. 362/184; 362/249.06; 362/231

(57) ABSTRACT

A light emitting diode (“LED”) does not have a filament or power cord, has its own self-contained power supply and which LED light maybe clipped onto a support to decorative effect.

### CROSS-REFERENCE TO RELATED APPLICATIONS

This application relates to and claims priority from and the benefit of U.S. provisional patent application Ser. No. 61/108,105, filed Oct. 24, 2008 and entitled Clip-On Decorative LED Light, by the same inventor hereof.

### TECHNICAL FIELD

This disclosure relates generally to decorative lights such as Christmas tree light strings and night lights and more particularly to a cordless clip-on light assembly.

### BACKGROUND

Decorative light bulb assemblies typically comprise a plurality of electric light bulbs, each housed in an electric fixture which supplies electric current to each bulb. Each such fixture is usually located on a common electric cord which supplies the necessary electric current to each fixture. The presence of the cord hinders the physical placement of the lights. It is usually necessary to make many adjustments in the position of the cord to string the lights in a desired position. Thus, the cord essentially dictates to a large extent the precise location of each light in the overall decorative scheme. Moreover, the electric cord presence detracts from the decorative visually effect of the light assembly.

Taking the example of “stringing” lights on a Christmas tree, not only is the cord an annoying and frustrating presence which interferes with placing the lights on the tree, it also dictates where the light can and cannot be placed. For example, it is often desirable to place some of the lights in the interior of the tree foliage, i.e., near the trunk. However, the presence of the cord renders such placement problematic. Thus, the cord may physically prevent the location of a particular light bulb at a certain interior location because the length of cord between the fixed light fixtures is not of a sufficient length. Moreover, the fact of a fixed cord length between fixtures prevents an appropriate distribution of lights in a three-dimensional space; i.e., the placement of a light near the trunk of the tree with the preceding and the following light placements to be made at the exterior of the tree must be made mindful of the fixed length of cord between the individual lights rather than any aesthetic or spatial considerations.

A further disadvantage of cord-strung lights is that the lights are incandescent bulbs. Burned out bulbs may be tricky to replace and often simply do not get replaced because the replacement bulbs have gotten lost or there are not enough replacement bulbs. Thus a decorative lighting scheme may be compromised by unreplaced burned out bulbs. In bulb strings that are wired in series, a burned out incandescent bulb may have the catastrophic effect of causing a failure of the whole string to illuminate because the filament is required to complete a series circuit.

It is an object of the present disclosure, therefore, to describe a light emitting diode (“LED”) light which does not have a filament, which has its own self-contained power supply and which LED light maybe clipped onto a support to decorative effect. Additional features and advantages of the clip-on light of the present disclosure will be evident from the accompanying description and drawings.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a diagrammatic illustration of a side view cross-section of a clip-on light of the present disclosure.

FIG. 2 is a diagrammatic illustration of a side view cross-section of the clip-on light of FIG. 1 in an energized state.

FIG. 3 is a diagrammatic illustration of a side view of an alternative light-powered embodiment of a clip-on light of the present disclosure.

FIG. 4 is a diagrammatic illustration of a side view of an alternative hanging ornament embodiment of a clip-on light of the present disclosure.

FIG. 5A-5C is a diagrammatic illustration of a side view of a clip-on light of the present disclosure having a variety clip designs.

FIG. 6 is a diagrammatic illustration of a side view of an alternative embodiment of a clip-on light of the present disclosure having a plurality of LEDs.

FIG. 7A illustrates a clip-on LED light assembly of the present disclosure fitted with a substantially round transparent or translucent decorative cover.

FIG. 7B illustrates a clip-on LED light assembly of the present disclosure fitted with a substantially flame-shaped transparent or translucent decorative cover.

FIG. 7C illustrates a clip-on LED light assembly of the present disclosure fitted with a substantially torpedo-shaped transparent or translucent decorative cover.

FIG. 7D illustrates a clip-on LED light assembly of the present disclosure fitted with a substantially pumpkin-shaped transparent or translucent decorative cover.

FIG. 7E illustrates a clip-on LED light assembly of the present disclosure fitted with a substantially star-shaped transparent or translucent decorative cover.

FIG. 7F illustrates a clip-on LED light assembly of the present disclosure fitted with a substantially ghost-shaped transparent or translucent decorative cover.

FIG. 7G illustrates a clip-on LED light assembly of the present disclosure fitted with a substantially heart-shaped transparent or translucent decorative cover.

FIG. 7H illustrates a clip-on LED light assembly of the present disclosure fitted with a substantially crescent moon-shaped transparent or translucent decorative cover.

FIG. 7I illustrates a clip-on LED light assembly of the present disclosure fitted with a substantially flower-shaped transparent or translucent decorative cover.

FIG. 7J illustrates a clip-on LED light assembly of the present disclosure fitted with a substantially rainbow-shaped transparent or translucent decorative cover.

FIG. 7K illustrates a clip-on LED light assembly of the present disclosure fitted with a substantially flag-shaped transparent or translucent decorative cover.

FIG. 7L illustrates a clip-on LED light assembly of the present disclosure fitted with a substantially firecracker-shaped transparent or translucent decorative cover.

FIG. 8 is a diagrammatic illustration of a side view of an alternative light-powered embodiment of a clip-on light of FIG. 3.

FIG. 9 is a diagrammatic illustration of a bottom view of an alternative embodiment of a clip-on light assembly of the present disclosure.

FIG. 10A is a diagrammatic illustration of a side view of an alternative embodiment of a clip of a clip-on light assembly of the present disclosure.

FIG. 10B is a diagrammatic illustration of a front view of the alternative embodiment of a clip of a clip-on light assembly of FIG. 10A.

FIG. 10C is a diagrammatic illustration of a front view of an alternative embodiment of the clip of FIG. 10B.

FIG. 10D is a diagrammatic illustration of a front view of another alternative embodiment of the clip of FIG. 10B.

FIG. 11 is a side partially exploded view of a specific exemplary embodiment of a lighting system of the present disclosure.

FIG. 12 is a top exploded view of an embodiment of FIG. 11.

FIG. 13 is a top isometric view of a battery assembly of a specific exemplary embodiment of a lighting system of the present disclosure with a transparent assembly housing to make the interior structure of the assembly visible.

FIG. 14 is a bottom isometric view of a battery assembly embodiment of FIG. 13.

### DETAILED DESCRIPTION

Light-emitting diode (LED) Christmas lights are quickly gaining popularity in many places due to their low energy usage (about one tenth the energy used by incandescent bulbs), very long lifetimes, and associated low maintenance. A light-emitting diode (LED) is a solid state semiconductor diode that emits light when an electrical current is applied in the forward direction of the device, as in the simple LED circuit. The effect is a form of electroluminescence where incoherent and narrow-spectrum light is emitted from the p-n junction. Colored LEDs are more efficient at producing light than their colored incandescent counterparts.

There are two types of LEDs: colored LEDs and white LEDs. Colored LEDs emit a specific color light (monochromatic light), regardless of the color of the transparent plastic lens that encases the LED's chip. The plastic may be colored for cosmetic reasons, but does not substantially affect the color of the light emitted. Because the light is determined by the LED's chip rather than the plastic lens, Christmas lights of this type do not suffer from color fading. In addition, the plastic lens is much more durable than the glass envelope of incandescent bulbs.

White LEDs are similar to colored LEDs in most respects such as power and durability, but utilize a two-stage process to create the white (polychromatic, or broad spectrum) light. In the first stage, the LED actually only produces one color of light, similar to any other LED. In the second stage, some of the blue or violet-blue is absorbed by a phosphor which fluoresces yellow, imitating the broad spectrum of colors which human eyes perceive as “white”.

White LEDs can be used as white Christmas lights, or can be used to create any other color through the use of colored refractors and lenses, similar to the more commonly used incandescent bulbs. Color fading may therefore occur due to the exposure of colored plastics to sunlight or heat, as with ordinary Christmas lights. Yellowing may also occur in the epoxy “bulb” in which the LED is usually encased if left in the sun consistently.

LEDs use much less electricity (only 4 watts for a 70-light string) and have a much greater lifespan than incandescent lamps. Since they are constructed from solid state materials and have no metallic filaments to burn out or break, LEDs are also much less susceptible to breakage from impact or rough handling.

Although LEDs themselves are long-life devices, older or lower-quality strands of LED-based Christmas lights can suffer from early failure. This is particularly so with blue ones, which are the newest and most expensive, and therefore prone to cost-cutting; in addition, spares are rarely included with sets. Most LED-based Christmas lights use copper wire which connects to the aluminum-based wires of the LEDs. Exposing this combination of metals to moisture can result in galvanic corrosion inside of the lamps' sockets, causing them to stop working. Many other sets use cheaper steel leads on the LEDs, which instead rust, leading to the same result. Some newer and higher-quality sets of LED Christmas lights have each LED permanently mounted in a non-removable weather-tight base to keep out rain and other moisture, helping to prevent such corrosion; however, this prevents the user from replacing defective bulbs.

Most common consumer LED lamps produce intense, deep, pure colors, versus incandescent bulbs which generally have subtler, yellow-tinted colors, often somewhat faded especially if used outside. Blue tends to be the dimmest incandescent color, but the brightest in LED, while yellow is just the opposite. Very early strings of LED lights were noticeably dimmer than incandescent bulbs, but now are often noticeably brighter. These factors combine to give LED lamps a distinct aesthetic from older incandescent strings, although white LEDs behind colored lenses do offer the ability to provide a more incandescent-type appearance with most of the benefits of energy efficiency. However, most use colored-chip type LEDs that produce the intense colors. This is largely due to the maturity of colored LED versus newer white LED technology, and as the technology improves so will the ability to change the aesthetics of the lamps, at lower cost than at present. As of 2007, “warm white” LED sets were common for the first time in U.S. stores, having a color similar to a compact fluorescent light. However, this color needs to be more of an orange tint to match the color of such small bulbs, because they burn at a lower temperature. Still, this is a significant improvement from the very cold-white (and often irregularly-tinted) color of early white sets.

Additionally, low-end sets do not contain power supplies (or have only a transformer instead of a SELV), and so the bulbs flicker in sync with the alternating current, being completely off when the voltage is negative. This produces a noticeable stroboscopic effect when an individual happens to move the lights across his or her field of view quickly, as when moving the eyes or turning the head rapidly. Higher-quality strings include a bridge rectifier to supply full-wave direct current to the lamps, making the lights brighter and greatly reducing the flickering (though there is still a small amount because diodes need a minimum voltage to begin conducting). Cheaper sets with two circuits connect each in the opposite polarity, which minimizes flicker in the combined light reflected from walls, and also keeps power consumption symmetrical so as not to affect the electrical system.

Many mini sets use standard 3 mm dome-shaped LEDs, and have a plastic cover over them to provide refraction, which is an important step in diffusing the unidirectional light they cast. These covers come in C5, C6, and C7 sizes (⅝, ¾, and ⅞-inch, or 16, 19, and 22 mm diameters, respectively) pointed “strawberries,” G12 (12 mm or almost ½-inch) globe “raspberries,” and “M5” (5 mm or 7/32-inch) pointed cylinders, equivalent to the T1¾ mini lights so common since the 1980s. For blue and green, these covers may have some fluorescence, leading to a lighter color. Other sets have 5 mm domes with no covers, though because these project light in one direction, many of these instead have a cone-shaped indentation on the top, refracting much of the light out to the sides. There are also multi-LED screw-in bulbs which replace real C7½ and C9¼ bulbs, and are much closer in brightness than the mini imitations.

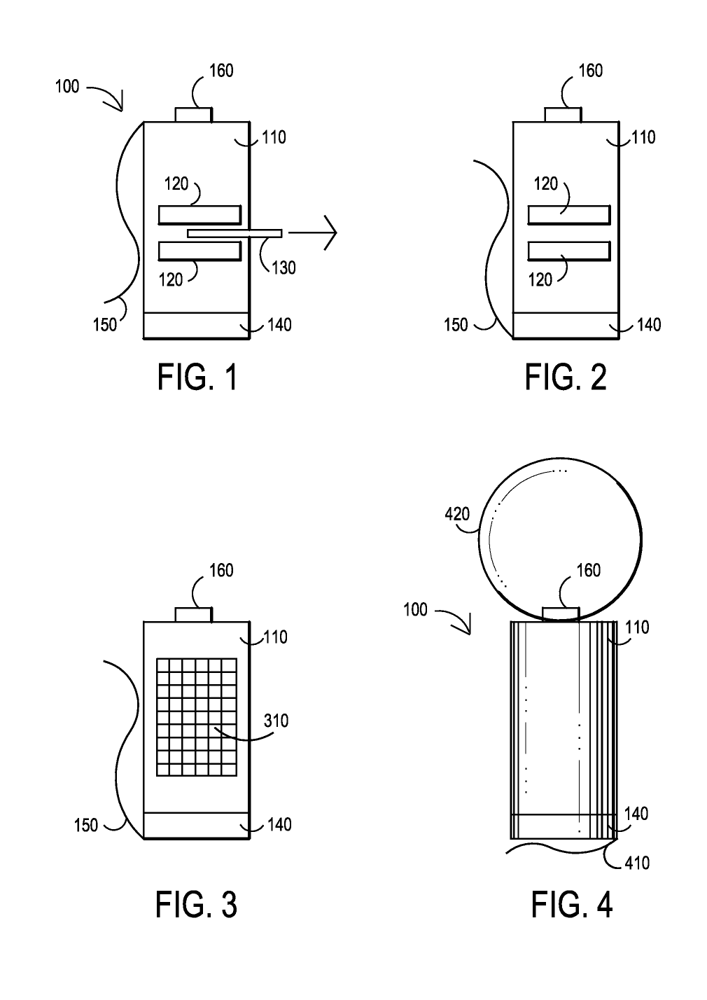

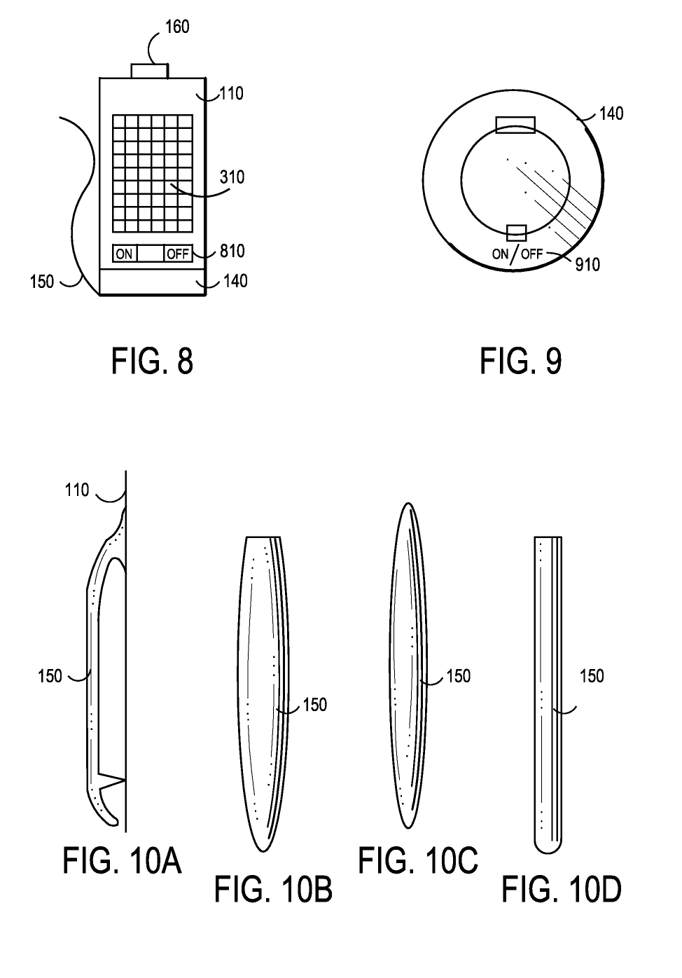

Referring now to FIG. 1 of the drawings, FIG. 1 is a diagrammatic illustration of a side view cross-section of a clip-on light of the present disclosure. The reference numeral 100 generally designates a clip-on light assembly of the present disclosure. Assembly 100 may include but not be limited to casing 110 housing one or more batteries 120 that may be activated by removing tab 130. Activated battery 120 provides power to illuminate Light Emitting Diode (“LED”) 160. Alternative embodiments of assembly 100 may further provide an on/off switch 810, 820 (see FIGS. 8 and 14) to selectively provide power to and illuminate LED 160 after removal of tab 130.

Assembly 100 may further include selectively removable cap 140 to access battery 120 within casing 110. Clip 150 coupled to casing 110 allows for selective mounting of assembly 100 to a desired support such as a Christmas tree limb.

FIG. 2 is a diagrammatic illustration of a side view cross-section of the clip-on light of FIG. 1 in an energized state. Tab 130 has been removed to bring batteries 120 into contact with electrodes (not shown) to provide an electric current to LED 160 causing LED 160 to light up. The embodiment of this FIG. 2 depicts an alternative positioning of clip 150 on the bottom of casing 110.

FIG. 3 is a diagrammatic illustration of a side view of an alternative light-powered embodiment of a clip-on light of the present disclosure. “Solar” or light-sensitive panel 310 is disposed on casing 110 and in electronic communication with battery 120 to provide electric power to LED 160. Specific embodiments may provide that battery 120 is re-chargeable by light-panel 310 with exposure to light so that LED 160 may be powered by battery 120 even in the absence of light after having been charged up by exposing panel 310 to light for a sufficient period of time.

FIG. 4 is a diagrammatic illustration of a side view of an alternative hanging ornament embodiment of a clip-on light of the present disclosure. Clip 410 is coupled to the bottom of battery cap 140, or generally to the bottom of assembly 100. Hollow sphere or orb 420 mounted over LED 160 becomes illuminated when LED 160 is illuminated, creating the effect of an ornamental illuminated bulb. When suspended from a desired support, the present embodiment may appear as a hanging decorative illuminated orb or globe.

Orb 420 may be provided in any desired color, including but not limited to red, silver, blue, green, yellow, white and frosted. LED 160 may also be provided in any one of a variety of colors such as, for example, red, blue, purple, orange, white and green.

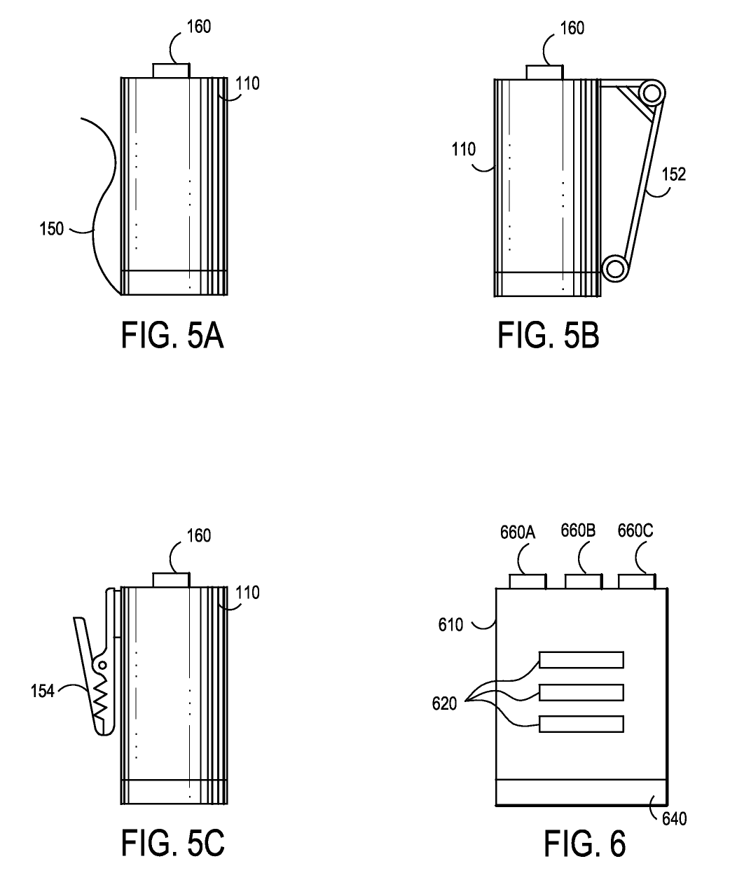

FIG. 5A-5C are diagrammatic illustrations of a side view of a clip-on light of the present disclosure having a variety clip designs:

FIG. 5A illustrates an S-clip mounted to the bottom of casing 110 for a hanging ornament embodiment as described above.

FIG. 5B illustrates a tension spring clip mounted to casing 110.

FIG. 5C illustrates an Alligator clip mounted to casing 110.

FIG. 6 is a diagrammatic illustration of a side view of an alternative embodiment of a clip-on light of the present disclosure having a plurality of LEDs. Dispose through casing 610 may be a plurality of LEDs 660A, 660B and 660C, for example. To power the LEDs, casing 610 may house two or more batteries 620. Accordingly, casing 610 may be larger than housing 110 of the embodiment of FIG. 1, for example, to accommodate the additional LEDS and batteries.

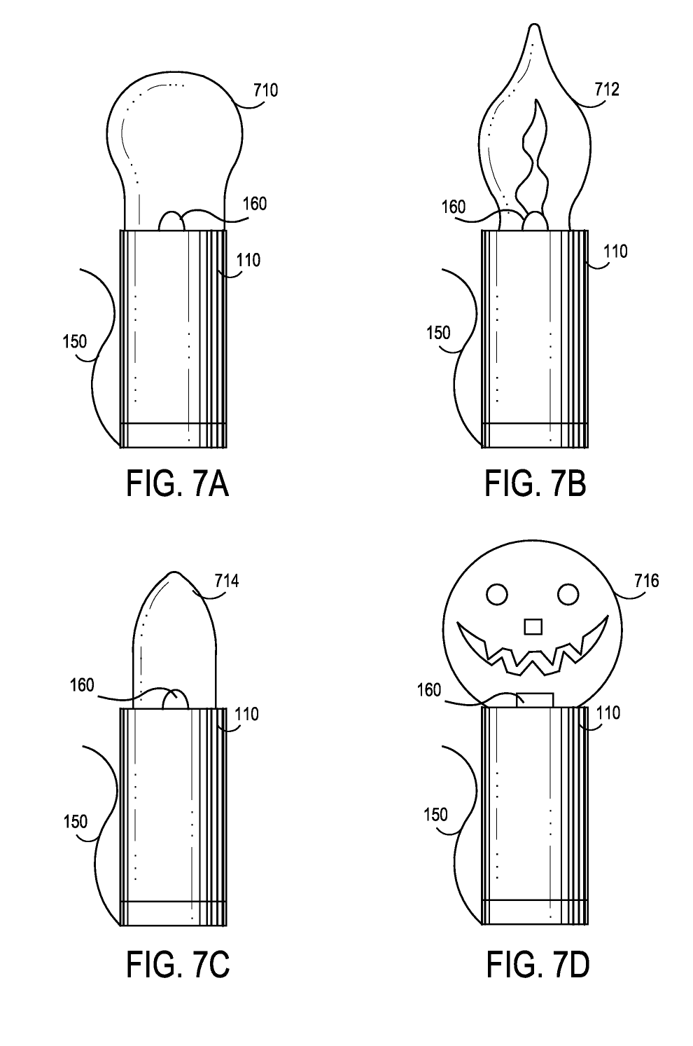

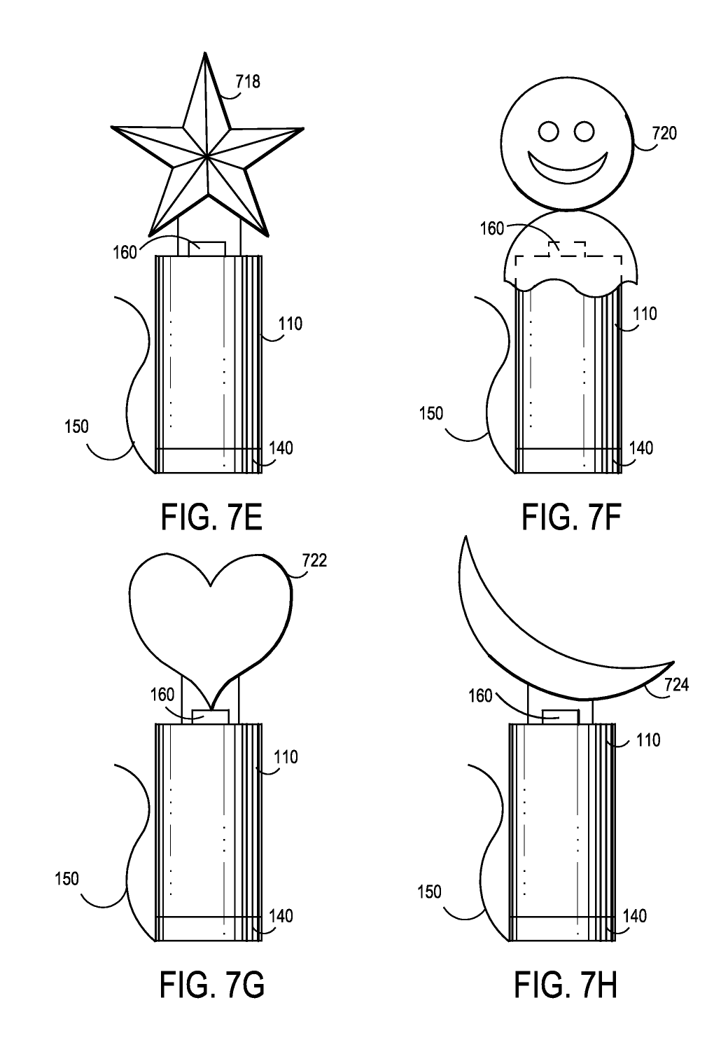

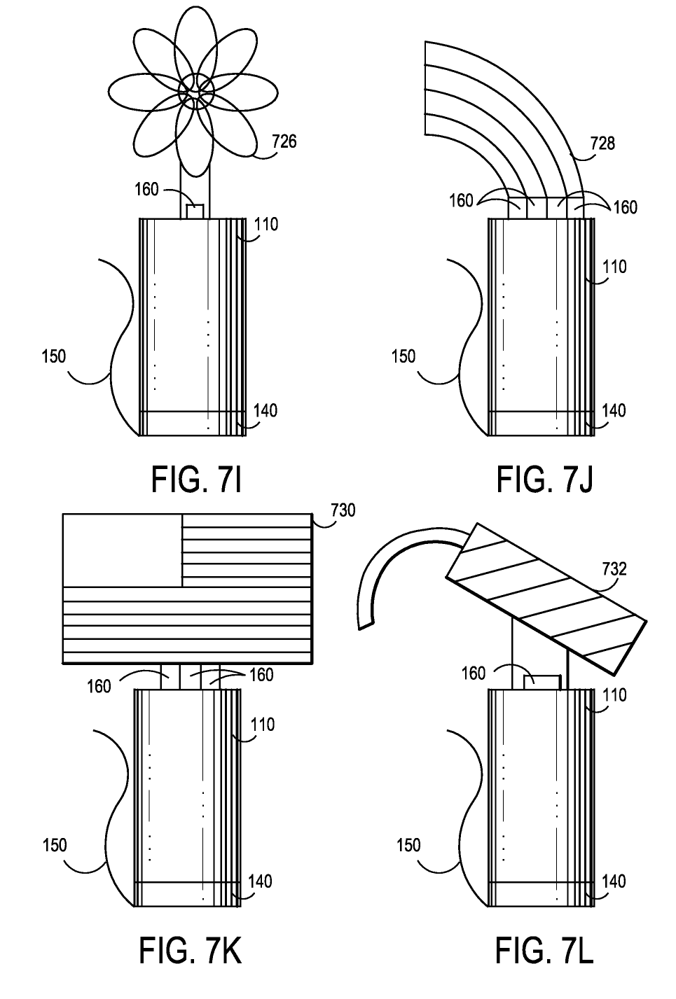

FIGS. 7A-L are diagrammatic illustrations of a side view of a clip-on light of the present disclosure having a variety of transparent or translucent decorative covers. Specific embodiments provide selectively removable and selectively attachable covers so that decorative covers suitable for a particular holiday or event may be swapped out on the a=light assembly. Alternative embodiments of the present light assembly may be provide in a kits or package having a plurality of selectively removable and attachable decorative covers.

FIG. 7A illustrates a clip-on LED light assembly of the present disclosure fitted with a substantially round transparent or translucent decorative cover 710.

FIG. 73 illustrates a clip-on LED light assembly of the present disclosure fitted with a substantially flame-shaped transparent or translucent decorative cover 712.

FIG. 7C illustrates a clip-on LED light assembly of the present disclosure fitted with a substantially torpedo-shaped transparent or translucent decorative cover 714.

FIG. 7D illustrates a clip-on LED light assembly of the present disclosure fitted with a substantially pumpkin-shaped transparent or translucent decorative cover 716.

FIG. 7E illustrates a clip-on LED light assembly of the present disclosure fitted with a substantially star-shaped transparent or translucent decorative cover 718.

FIG. 7F illustrates a clip-on LED light assembly of the present disclosure fitted with a substantially ghost-shaped transparent or translucent decorative cover 720.

FIG. 7G illustrates a clip-on LED light assembly of the present disclosure fitted with a substantially heart-shaped transparent or translucent decorative cover 722.

FIG. 7H illustrates a clip-on LED light assembly of the present disclosure fitted with a substantially crescent moon-shaped transparent or translucent decorative cover 724.

FIG. 7I illustrates a clip-on LED light assembly of the present disclosure fitted with a substantially flower-shaped transparent or translucent decorative cover 726.

FIG. 7J illustrates a clip-on LED light assembly of the present disclosure fitted with a substantially rainbow-shaped transparent or translucent decorative cover 728.

FIG. 7K illustrates a clip-on LED light assembly of the present disclosure fitted with a substantially flag-shaped transparent or translucent decorative cover 730.

FIG. 7L illustrates a clip-on LED light assembly of the present disclosure fitted with a substantially firecracker-shaped transparent or translucent decorative cover 732.

FIG. 8 is a diagrammatic illustration of a side view of an alternative light-powered embodiment of a clip-on light of FIG. 3. On/Off switch 810 is coupled to the power source such as solar/light array 310 or battery 120 to selectively turn LED 160 on or off.

FIG. 9 is a diagrammatic illustration of a bottom view of an alternative embodiment of a clip-on light assembly of the present disclosure. On/Off switch 910 is coupled to the power source such as battery 120 to selectively turn LED 160 on or off.

FIG. 10A is a diagrammatic illustration of a side view of an alternative embodiment of a clip of a clip-on light assembly of the present disclosure. Clip 150 of this alternative embodiment resembles a pen-type clip.

FIG. 10B is a diagrammatic illustration of a front view of the alternative embodiment of a clip of a clip-on light assembly of FIG. 10A. Clip 150 has a bullet-shaped profile from this view.

FIG. 10C is a diagrammatic illustration of a front view of an alternative embodiment of the clip of FIG. 10B. Clip 150 has a torpedo-shaped profile from this view.

FIG. 10D is a diagrammatic illustration of a front view of another alternative embodiment of the clip of FIG. 10B. Clip 150 has a rod-shaped profile from this view.

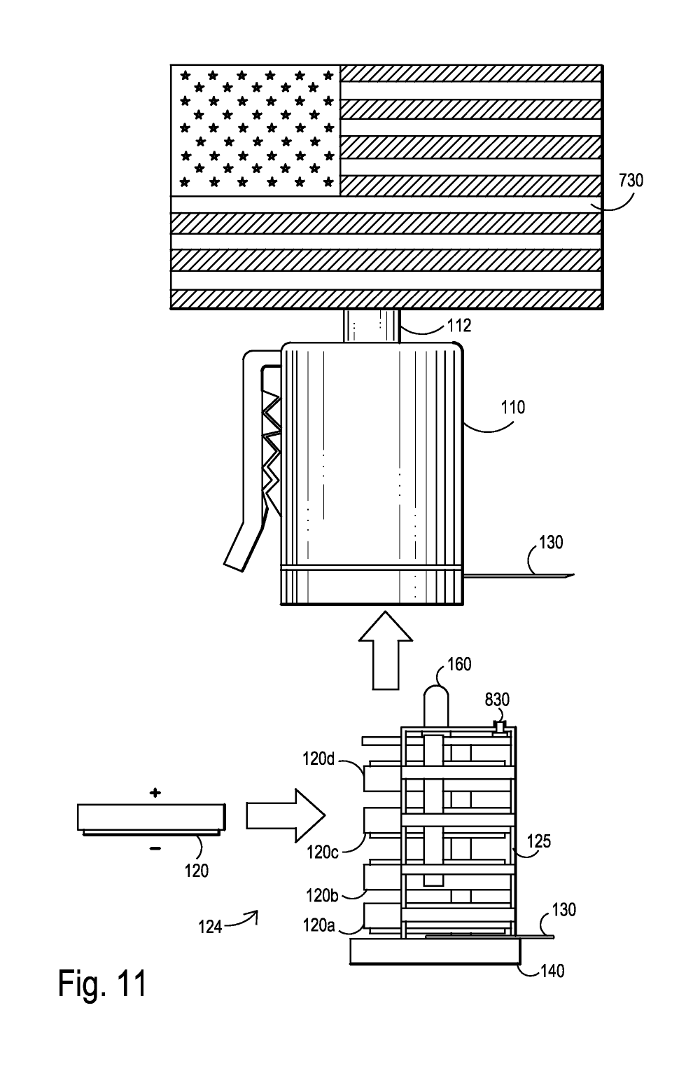

FIG. 11 is a side partially exploded view of a specific exemplary embodiment of a lighting system of the present disclosure. FIG. 11 illustrates an alternative embodiment having a battery assembly 124 with a plurality of batteries 120a, 120b, 120c, 120d assembled on scaffold support 125. Battery 120 is housed in battery case 140. Insulator tab 130 prevents premature completion of the battery circuit. The batter circuit is activated by removing tab 130 with a tug to bring the electrodes of the batteries into contact and complete the electrical circuit. LED light 160 is mounted on the top of assembly 124 in electrical communication with the batteries. On/Off switch 830 is located near LED 160 at the top of support 125 in this alternative embodiment.

Assembly 124 fits into house 110 having clip 156. Note that clip 156 depicted in FIG. 11 illustrates yet another alternative embodiment of such a clip, here having meshing teeth on the prongs of the clip. LED 160 fits into recess 112 and illuminates decoration 730 upon activation of the battery assembly 124 by pulling tab 130.

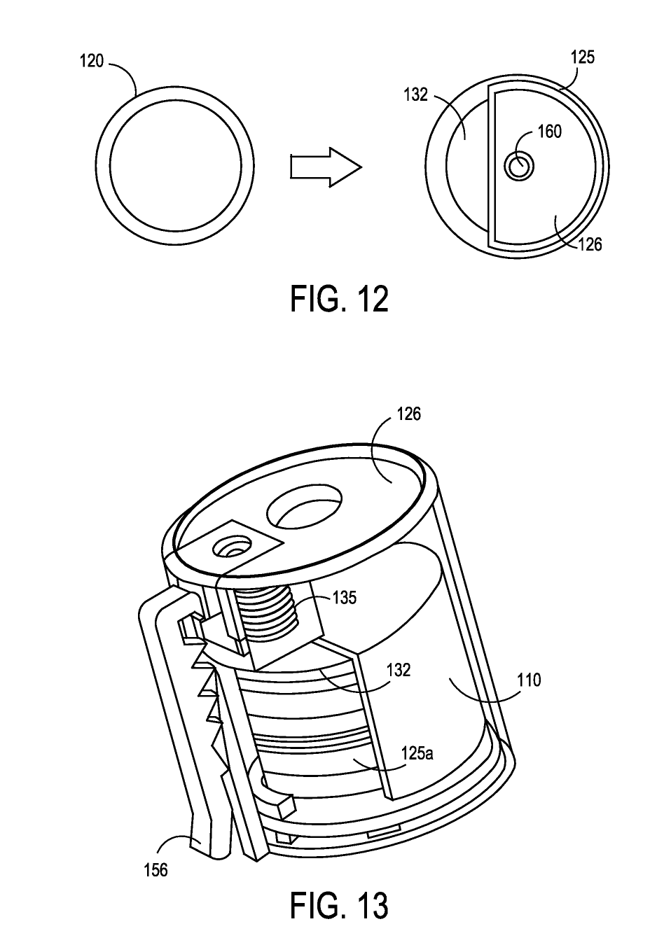

FIG. 12 is a top exploded view of an embodiment of FIG. 11. Battery 120 is housed in assembly support 125. LED 160 protrudes from the top of support 125. Shoulder 132 is exposed from under support 125 top 126.

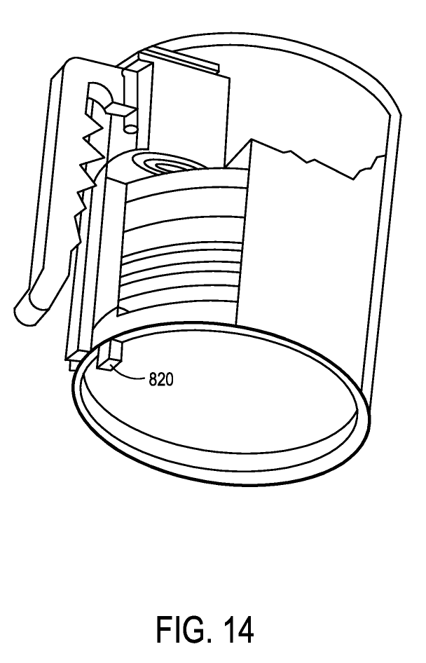

FIG. 13 is a top isometric view of a battery assembly of a specific exemplary embodiment of a lighting system of the present disclosure with a transparent assembly housing 110 to make the interior structure of the battery assembly 125a visible. Battery assembly 125a (here, a two battery embodiment rather than the 4 battery embodiment 125 of FIG. 11) is disposed in housing 110. Spring 135 is mounted above battery assembly shoulder 132 to provide a downward spring bias on the batteries of assembly 125a. The downward spring bias enhances the electrical contact between the batteries and improves operational reliability of the lighting system after removal of tab 130. Alternative embodiments provide a leaf spring rather than a coil spring, but any suitable biasing mechanism is contemplated by the present disclosure.

FIG. 14 is a bottom isometric view of a battery assembly embodiment of FIG. 13. This alternative embodiment provides an on/off switch on the underside of battery assembly 125a.

A clip-on light assembly of the present disclosure provides numerous advantages over traditional incandescent strung light products. Durable LEDs are resistant to breakage and fading. LEDs are cool to the touch and reduce fire risk when used indoors relative to incandescent bulbs. Typical LEDs achieve approximately 20,000 hours of life. LEDs are available in flickering or blinking embodiments for those who desire such effects. A single LED assembly of the present disclosure may display in more than one color. For example red, white and blue for patriotic holidays.

Kits or packages of clip-on LEDs of the present disclosure may include a plurality of selectively removable and selectively attachable decorative covers and instructions for how to activate the battery or power supply and other features of the product.

The clip-on feature allows greater flexibility of arrangement of lights than do strings of lights.

The present disclosure contemplates both indoor and outdoor uses of the LED lights described herein. To inhibit the presence of water within casing 110 or within any of the electrical power circuits of assembly 100, substantially waterproof, water resistant, and sealed embodiments of assembly 100 are contemplated. Such substantially waterproof and the like embodiments may be particularly advantageous for outdoor use.

The present disclosure contemplates the use of a great variety of battery types with light assembly 100 as well as solar or light power. For example, in addition to common disposable alkaline batteries often available in AA, AAA, D and D sizes, 9 volt batteries and button-type silver-oxide batteries, embodiments that may use rechargeable batteries including lithium-ion batteries are also contemplated.

Many modifications and other embodiments of the LED light assembly will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the disclosure. Although specific terms are employed herein, they are used in a generic and descriptive sense only and not for purposes of limitation.

What is claimed is:

1. A system for decorating an object with lights, the system comprising:
a plurality of unconnected LED lights;
a plurality of power supplies such that, at least one power supply is connected to each LED light of the system, wherein each LED light is powered by a power supply connected only to said LED light; and
a plurality of fasteners such that at least one fastener is attached to each LED light,
wherein the each fastener selectively attaches to the object to fasten one of the LED lights to the object to decorate the object with one or more of the plurality of unconnected LED lights.

2. The system of claim 1, wherein at least one of the LED lights is colored.

3. The system of claim 1 wherein at least one of the LED lights is not colored.

4. The system of claim 1, wherein at least one of the power supplies is selectively activatable.

5. The system of claim 1, wherein the fastener is selectively detachable from the object.

6. The system of claim 1, wherein the power supply connected to at least one of the LED lights comprises a battery.

7. The system of claim 1, further comprising a plurality of decorative covers attachable to one or more of the LED lights

8. The system of claim 7, wherein the decorative covers are selectively attachable and detachable from the LED lights so that the covers are interchangeable on the LED lights.

9. A kit of LED light assemblies for decorating on object, the kit comprising:
a plurality of unconnected LED light assemblies where in each assembly further comprises at least one LED light, at least one power supply connected only to said LED light, and at least one fastener attached to said LED light for fastening the LED light to the object; and
a set of instructions for use of the LED light assemblies to decorate the object.

10. The kit of claim 9, wherein at least one of the LED lights is colored.

11. The kit of claim 9, wherein at least one of the LED lights is not colored.

12. The kit of claim 9, wherein at least one of the power supplies is selectively activatable.

13. The kit of claim 9, wherein the fastener is selectively detachable from the object.

14. The kit of claim 9, wherein the power supply connected to at least one of the LED lights comprises a battery.

15. The kit of claim 9, further comprising a plurality of decorative covers attachable to one or more of the LED lights

16. The kit of claim 15, wherein the decorative covers are selectively attachable and detachable from the LED lights so that the covers are interchangeable on the LED lights.
